(19) United States
(12) Patent Application Publication
(10) Pub. No.: US 2005/0083488 A1
(43) Pub. Date: Apr. 21, 2005

(54) Light device having light concentrating device

(76) Inventor: Ming Huang Huang, Hsin Chuang City (TW)

Correspondence Address: CHARLES E. BAXLEY ESQ, 90 JOHN STREET, 3RD FLOOR, NEW YORK, NY, 10038, US

(21) Appl. No.: 10/693,514

(22) Filed: Oct. 21, 2003

(51) Int. Cl. G03B 21/18

(52) U.S. Cl. 353/58

(57) ABSTRACT

A projector light device includes a housing having a supporting panel, a board attached to the panel, one or more light members attached to the board for generating lights, and a plate disposed in front of the board and having one or more lenses arranged in front of the light members, for concentrating the lights generated by the light members, and for increasing projecting distances of the lights generated by the light members. Each of the light members includes a seat having an orifice for receiving a light element. A cover may be disposed in front of the plate, and a camera may be attached to the housing for video taping purposes or for taking pictures.

### BACKGROUND OF THE INVENTION

1. Field of the Invention

The present invention relates to a projector light device, and more particularly to a projector light device having a light concentrating device for concentrating the light, and for increasing the light projecting distance.

2. Description of the Prior Art

Typical projector light devices have been provided for project light beams onto far away objects, and comprise a number of light members, such as the typical light bulbs, the light emitting diodes, etc. attached to a board.

However, the typical projector light devices have no devices for concentrating the light, such that the light generated by the typical projector light devices may only be emitted for a projecting distance of about 20 to 25 meters only, such that the objects farther than 25 meters may not be clearly lighted by the typical projector light devices.

The present invention has arisen to mitigate and/or obviate the afore-described disadvantages of the conventional projector light devices.

### SUMMARY OF THE INVENTION

The primary objective of the present invention is to provide a projector light device having a light concentrating device including a light concentrating device for concentrating the light, and for increasing the light projecting distance.

In accordance with one aspect of the invention, there is provided a projector light device comprising a housing including a supporting panel provided therein, a board attached to the panel, a plurality of light members attached to the board for generating lights, and a plate disposed in front of the board, and including at least one lens provided therein and arranged in front of the light members, for concentrating the lights generated by the light members, and for increasing projecting distances of the lights generated by the light members.

Each of the light members includes a seat having an orifice formed therein, and a light element received in the orifice of the seat. Each of the light members includes at least one pair of conductors extended therefrom.

A cover may further be provided and disposed in front of the plate, and including a transparent sheet provided therein, and arranged in front of the light members, for shielding and protecting the light members, and for allowing the light generated by the light members to emit out through the transparent sheet of the cover.

A hood may further be provided and attached onto the housing, for shielding the housing. A camera may further be provided and attached to the housing for video taping purposes or for taking pictures.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a projector light device in accordance with the present invention;

FIG. 2 is a partial exploded view of the projector light device;

FIG. 3 is another partial exploded view of the projector light device;

FIG. 4 is a partial cross sectional view of the projector light device, taken along lines 4-4 of FIG. 3;

FIG. 5 is a perspective view illustrating one of the light members of the projector light device; and

FIG. 6 is a perspective view similar to FIG. 1, illustrating the other arrangement of the projector light device.

### DETAILED DESCRIPTION OF THE PREFERRED EMBODIMENT

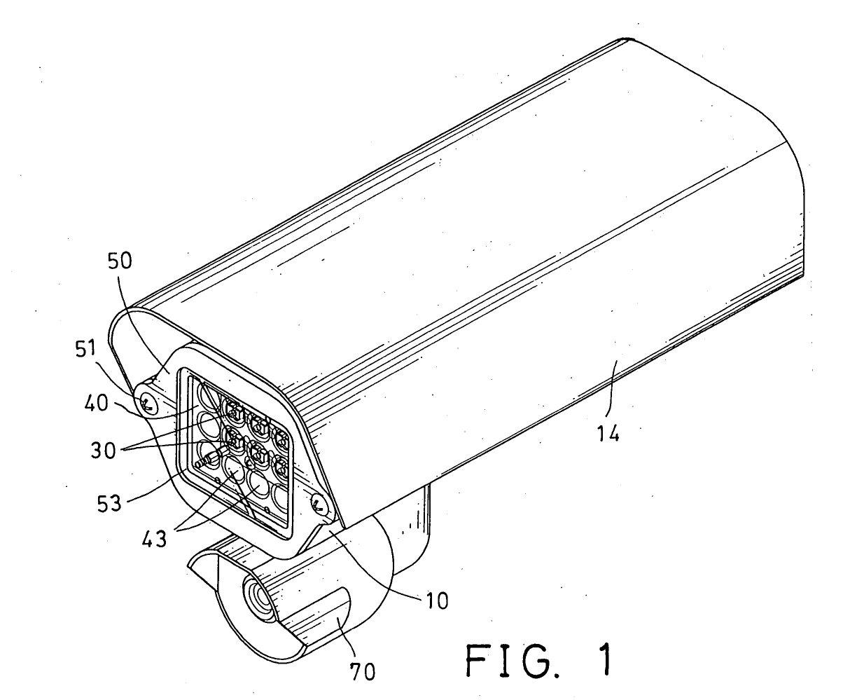

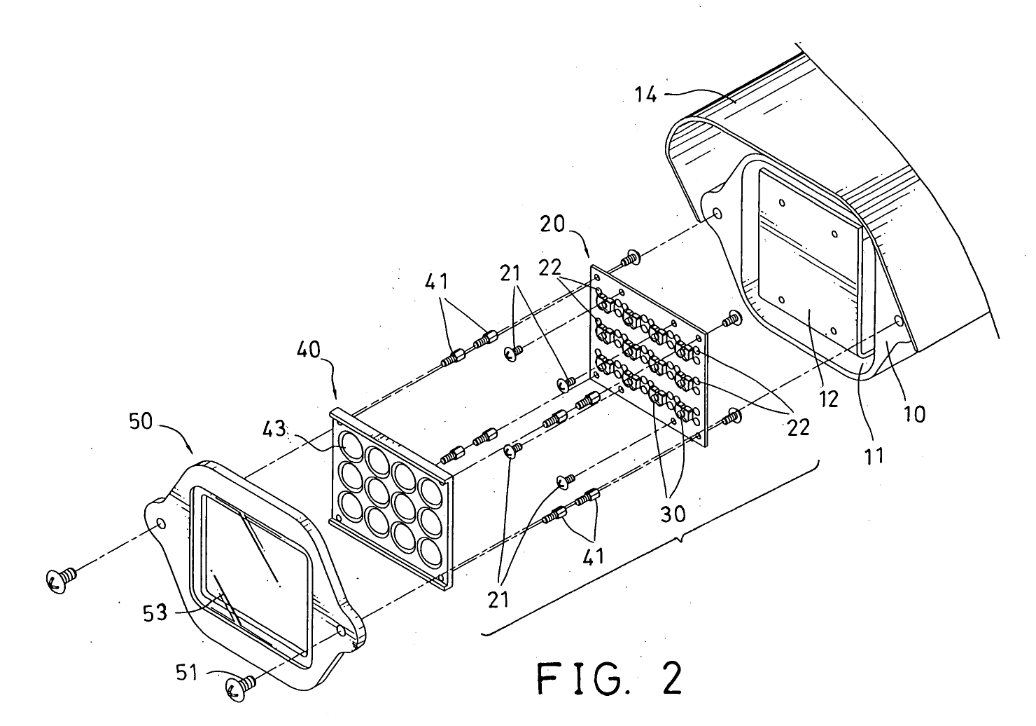

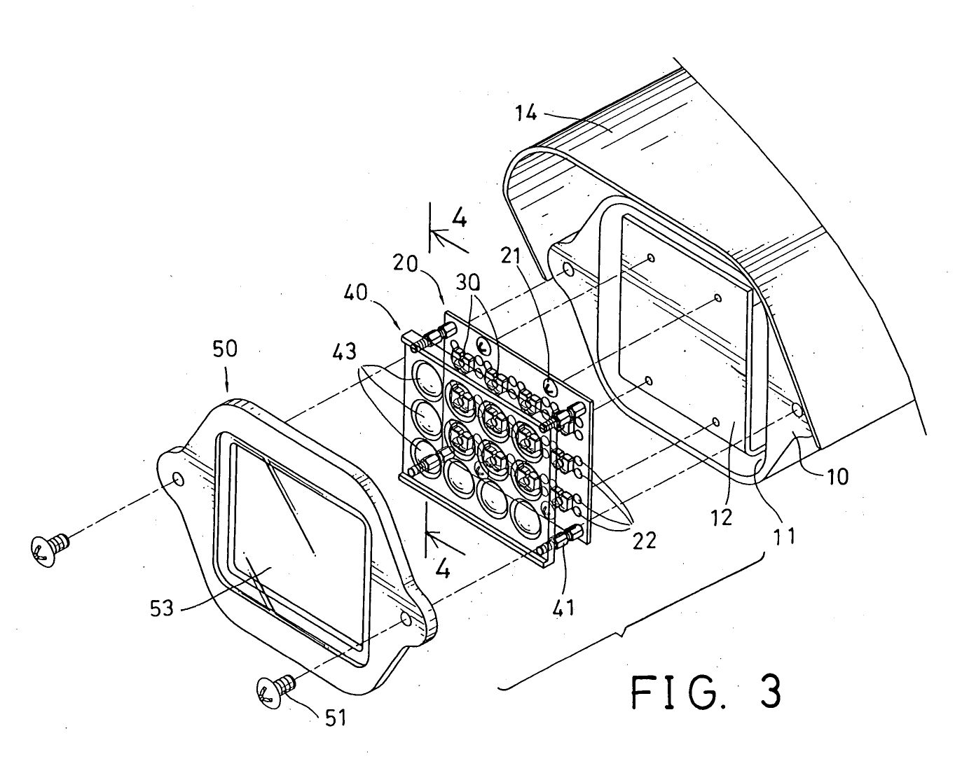

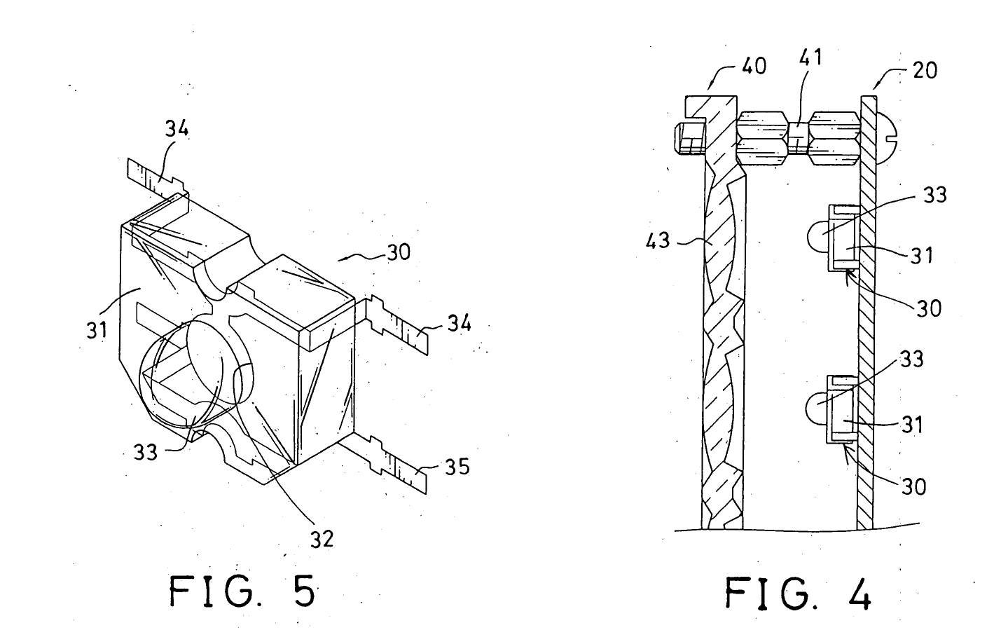

Referring to the drawings, and initially to FIGS. 1-4, a projector light device in accordance with the present invention comprises a housing 10 including a chamber 11 formed therein for receiving a supporting panel 12 therein, and a hood 14 attached onto the housing 10, for shielding or protecting the housing 10 from sun shine and rain, or the like.

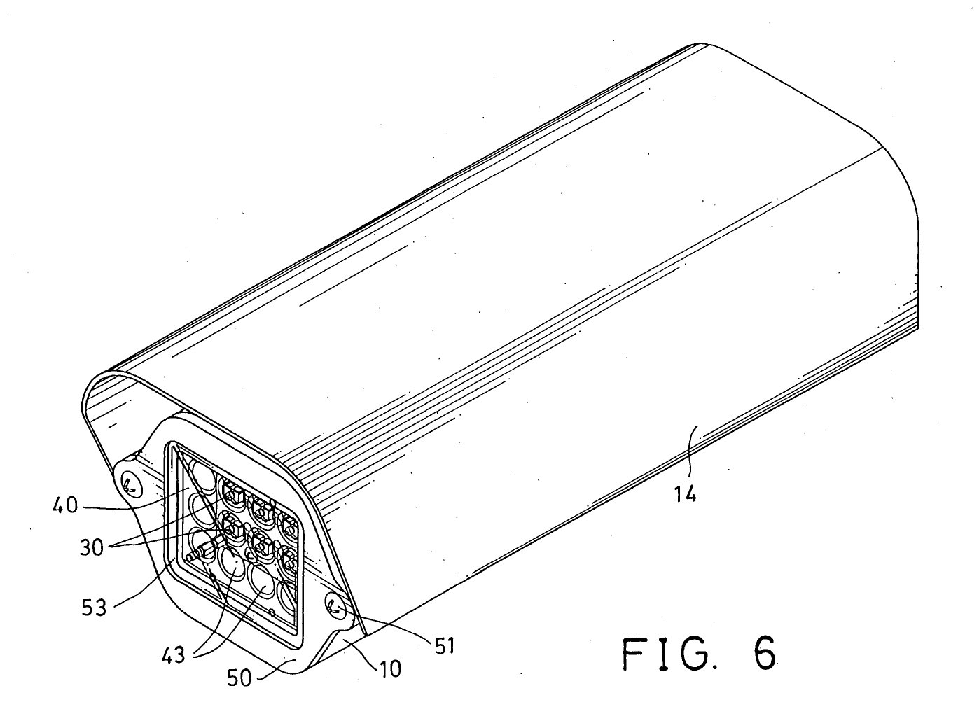

A board 20, such as a circuit board 20 is secured to the panel 12 with fasteners 21, for supporting one or more light members 30 thereon, and includes a number of holes or conductors 22 applied or provided thereon. As shown in FIG. 5, each of the light members 30 includes a seat 31 having an orifice 32 formed therein for receiving a light element 33 therein, such as the light bulbs, the light emitting diodes, etc.

Each of the light members 30 further includes one or more pairs of conductors 34, 35 extended therefrom and coupled to the light element 33, and engaged through or coupled to the conductors 22 of the circuit board 20, for electrically coupling the light element 33 to the circuit board 20. The light members 30 may be used for generating or emitting various lights, such as infrared lights or rays, etc.

A plate 40 may be secured to the front portion of the circuit board 20 or the panel 12 of the housing 10 with fasteners 41, and includes one or more convex lenses 43 provided therein, and aligned with the light members 30, and arranged in front of the light members 30, for concentrating the light generated by the light members 30. It is preferable that the board 20 and the plate 40 and the light members 30 are received and protected within the chamber 11 of the housing 10.

A cover 50 may further be provided and secured to the front portion of the plate 40 or the housing 10 with fasteners 51, and includes a transparent or glass sheet 53 provided therein, and arranged in front of the light members 30, for shielding and protecting the light members 30, and for allowing the light generated by the light members 30 to emit out through the transparent or glass sheet 53 of the cover 50.

As shown in FIG. 1, a video camera 70 or the like may further be provided and secured to the bottom of the housing 10, for taping purposes. The light generated by the light members 30 may be concentrated by the lenses 43 of the plate 40 and may project for a farther distance to clearly light objects at farther distances away from the users or away from the video camera 70.

Alternatively, as shown in FIG. 6, without the video camera 70, the projector light device in accordance with the present invention may also be attached onto various objects, such as vehicles, or the like, for lighting various objects at farther distances away from the users or away from the video camera 70.

Accordingly, the projector light device in accordance with the present invention includes a light concentrating device for concentrating the light and for increasing the light projecting distance.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A projector light device comprising:
a housing including a supporting panel provided therein,
a board attached to said panel,
a plurality of light members attached to said board for generating lights, and
a plate disposed in front of said board, and including at least one lens provided therein and arranged in front of said light members, for concentrating the lights generated by said light members, and for increasing projecting distances of the lights generated by said light members,
a cover disposed in front of said plate, and including a transparent sheet provided therein, and arranged in front of said light members, for shielding and protecting said light members, and for allowing the light generated by said light members to emit out through said transparent sheet of said cover.

2. The projector light device as claimed in claim 1, wherein each of said light members includes a seat having an orifice formed therein, and a light element received in said orifice of said seat.

3. The projector light device as claimed in claim 1, wherein each of said light members includes at least one pair of conductors extended therefrom.

4-5. (canceled)

6. The projector light device as claimed in claim 1 further comprising a camera attached to said housing.
